(19) United States
(12) Patent Application Publication
(10) Pub. No.: US 2025/0220762 A1
(43) Pub. Date: Jul. 3, 2025

(54) METHODS AND APPARATUSES OF MULTICAST SERVICE

(71) Applicant: LENOVO (BEIJING) LIMITED, Beijing (CN)

(72) Inventors: Mingzeng DAI, Shanghai (CN); Congchi ZHANG, Shanghai (CN); Lianhai WU, Beijing (CN)

(21) Appl. No.: 18/852,865

(22) PCT Filed: Apr. 1, 2022
(86) PCT No.: PCT/CN2022/084899

§ 371 Date: Sep. 30, 2024

(51) Int. Cl. H04W 76/27; H04W 68/00; H04W 76/40

(52) U.S. Cl. CPC H04W 76/27; H04W 68/005; H04W 76/40

(57) ABSTRACT

Embodiments of the present application are related to methods and apparatuses for point-to-multipoint (PTM) configuration for multicast service. An embodiment of the present application provides a user equipment (UE) including: receive multicast in a radio resource control (RRC) non-connected state; and a transmitter configured to: transmit a request of PTM configuration information for multicast reception in the RRC non-connected state; or transmit information associated with multicast reception of the UE after an initiation of state transition from the RRC non-connected state to a RRC connected state to assist deciding a subsequent RRC state used for the multicast reception.

### TECHNICAL FIELD

Embodiments of the present disclosure generally relate to wireless communications, and especially relate to point-to-multipoint (PTM) configuration for multicast service.

### BACKGROUND OF THE INVENTION

In new radio (NR) release (R)17, multicast/broadcast services (MBS) plans to focus on a small area mixed mode multicast (also referred to as Objective A in the TR 23.757). The Objective A is about enabling general MBS services over 5G system (5GS) and the identified use cases that could benefit from this feature. These use cases include but are not limited to: public safety and mission critical, vehicle to everything (V2X) applications, transparent internet protocol version 4 (IPv4)/internet protocol version 6 (IPv6) multicast delivery, internet protocol television (IPTV), software delivery over wireless, group communications and internet of things (IoT) applications.

Meanwhile, the work item on NR support of MBS was also agreed in R17 (e.g., RP-201038), wherein MBS reception in all radio resource control (RRC) states, i.e., RRC_IDLE state, RRC_INACTIVE state and RRC_CONNECTED state should be supported.

As the MBS reception is supported in all RRC states, it is necessary that multicast reception is supported in all RRC states; otherwise, various issues, e.g., service interruption, data loss, or large delay etc., will happen during the transition between different RRC states for multicast reception. Taking multicast reception as an example, it is only supported in RRC_CONNECTED state in R17. When a user equipment (UE) transits from RRC_CONNECTED state to RRC_INACTIVE state or RRC_IDLE state, it cannot receive multicast, e.g., multicast session(s) or multicast radio bearer(s). Thus, an improved technical solution for how to support multicast reception in RRC_INACTIVE state should be seriously considered

When a user equipment (UE) is in a RRC connected state, it may receive PTM configuration information of a MBS radio bearer (MRB) via RRC dedicated signaling, e.g., RRCReconfiguration message. Then the UE may enter a RRC inactive state later, and may perform multicast reception for the multicast MRB in RRC inactive state based on the received PTM configuration information.

When a network, e.g., a base station (BS) requires updating the PTM configuration, it may send a paging message to the UE for notifying the UE to enter into the RRC connected state. After reception of the paging message, the UE may perform RRC state transition from the RRC inactive state to the RRC connected state. After the UE enters the RRC connected state, the network (or the BS) may transmit the updated PTM configuration information to the UE via e.g., RRCReconfiguration message. After the UE update the PTM configuration, the network, e.g., the BS may send the UE back to the RRC inactive state e.g., via the RRCRelease message.

### SUMMARY

Embodiments of the present disclosure provide a method and apparatus related to multicast service, e.g., PTM configuration update for multicast service and determination of RRC state for multicast reception etc.

Some embodiments of the present disclosure provide a UE, including: a receiver configured to: receive multicast in a RRC non-connected state; and a transmitter configured to: transmit a request of PTM configuration information for multicast reception in the RRC non-connected state; or transmit information associated with multicast reception of the UE after an initiation of state transition from the RRC non-connected state to a RRC connected state to assist deciding a subsequent RRC state used for the multicast reception.

In some embodiments of the present disclosure, the request of PTM configuration information is transmitted via a RRC resume request message, and updated PTM configuration information is received via a RRC release message in response to the RRC resume request message without entering the RRC connected state.

In some embodiments of the present disclosure, the request of PTM configuration information is transmitted in response to receiving a paging message with an indication indicating that update of the PTM configuration information for the multicast is required.

In some embodiments of the present disclosure, the request of PTM configuration information is transmitted in response to receiving a paging message with a multicast broadcast service (MBS) session identifier (ID) of the multicast reception in the case that the UE is receiving or is interested in the MBS session identified by the MBS session ID.

In some embodiments of the present disclosure, the request of PTM configuration information is transmitted in response to cell selection or cell reselection to a cell without valid PTM configuration information for the UE.

In some embodiments of the present disclosure, the UE triggers to transit to the RRC connected state in response to a cell reselection or cell selection to a cell without valid PTM configuration information or reception of a paging message indicating that update of the PTM configuration information is required.

In some embodiments of the present disclosure, the information associated with multicast reception is transmitted via a RRC resume complete message, UE assistance information message, or MBS interest indication message.

In some embodiments of the present disclosure, the information associated with multicast reception includes at least one of: latest measurement results of a serving cell in the RRC non-connected state; a UE preference indication on RRC state of multicast reception; or a multicast reception status of the UE in the RRC non-connected state.

Some embodiments of the present disclosure provide a BS, including: a transceiver; and a processor coupled to the transceiver, wherein the processor is configured to: a): receive, via the transceiver, a request of PTM configuration information for multicast reception from a UE in a RRC non-connected state; and transmit, via the transmitter, the requested PTM configuration information; or b): receive, via the transceiver, information associated with multicast reception from the UE after an initiation of state transition of the UE from the RRC non-connected state to a RRC connected state; and determine a subsequent RRC state used for the multicast reception of the UE based on the received information.

In some embodiments of the present disclosure, the request of PTM configuration information is received via a RRC resume request message, and updated PTM configuration information is transmitted via a RRC release message in response to the RRC resume request message.

In some embodiments of the present disclosure, the request of PTM configuration information is received after transmitting a paging message with an indication indicating that update of the PTM configuration information for the multicast is required.

In some embodiments of the present disclosure, the request is received after transmitting a paging message with an MBS session ID of the multicast.

In some embodiments of the present disclosure, the BS includes a central unit (CU) and a distributed unit (DU) coupled to the CU, and the DU transmits the paging message to the UE in response to receiving a radio access network (RAN) paging message including an indication indicating that update of the PTM configuration information is required from the CU.

In some embodiments of the present disclosure, the CU is configured to transmit the RAN paging message to the DU in response to that the DU transmits a non-UE associated PTM configuration update request message to the CU.

In some embodiments of the present disclosure, the non-UE associated PTM configuration update request message includes at least one of the following: an MRB ID; an MBS session ID; a group radio network temporary identifier (G-RNTI); or a cell ID.

In some embodiments of the present disclosure, the BS is a receiving BS of the UE in response to receiving the request of PTM configuration information from the UE, and the BS is further configured to: transmit a UE context retrieve request message to a last serving BS of the UE, wherein the UE context retrieve request message includes a Xn interface request of PTM configuration information; receive a UE context retrieve response message from the last serving BS; and generate the PTM configuration information at least partly based on the UE context retrieve response message.

In some embodiments of the present disclosure, the information associated with multicast reception is received via a RRC resume complete message, UE assistance information message, or MBS interest indication message.

In some embodiments of the present disclosure, the information associated with multicast reception includes at least one of the following: latest measurement results in a serving cell in the RRC non-connected state; a UE preference indication on RRC state of multicast reception; or a multicast reception status of the UE in the RRC non-connected state.

Some embodiments of the present disclosure provide a method performed by a UE. The method includes: receiving multicast in a RRC non-connected state; and transmitting: a request of PTM configuration information for multicast reception in the RRC non-connected state; or information associated with multicast reception of the UE after an initiation of state transition from the RRC non-connected state to a RRC connected state to assist deciding a subsequent RRC state used for the multicast reception.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates an exemplary flow chart of a method performed by a UE according to some embodiments of the present disclosure.

FIG. 2 illustrates an exemplary procedure of the method according to some embodiments of the present disclosure.

FIG. 3 illustrates an exemplary procedure of the method according to some embodiments of the present disclosure.

FIG. 4 illustrates an exemplary procedure of the method according to some embodiments of the present disclosure.

FIG. 5 illustrates an exemplary procedure of the method according to some embodiments of the present disclosure.

FIG. 6 illustrates an exemplary flow chart of a method performed by a BS (or a network) according to some embodiments of the present disclosure.

FIG. 7 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

In a scenario of multicast service, a UE may perform multicast reception in a RRC inactive state based on PTM configuration received from a network, e.g., from a BS. When the network or the BS requires updating the PTM configuration, it may send paging message to the UE to notify the UE to enter the RRC connected state. After the UE enters the RRC connected state, the network or the BS may transmit the updated PTM configuration information to the UE. After the UE received the updated PTM configuration, the network or the BS may set the UE back into the RRC inactive state to continue the multicast reception.

However, these frequent RRC state transitions may cause large communication latency, signaling overhead, large service interruption, and deteriorated user experience.

At least to solve the above technical problems, embodiments of the present disclosure provide a solution, which can mitigate these adverse effects and improve the user experience.

According to some embodiments of the present disclosure, a UE in the RRC non-connected state, e.g., RRC inactive state may transmit a request of PTM configuration information for the multicast reception. In some other embodiments of the present application, a RRC non-connect state may refer to a RRC idle state.

The UE may transit from the RRC non-connected state to a RRC connected state. According to some embodiments of the present disclosure, after the UE initiates a state transition from a RRC non-connected state to a RRC connected state, the UE may transmit information associated with multicast reception to the network or BS, to assist the network to determine a subsequent RRC state of the UE used for the multicast reception.

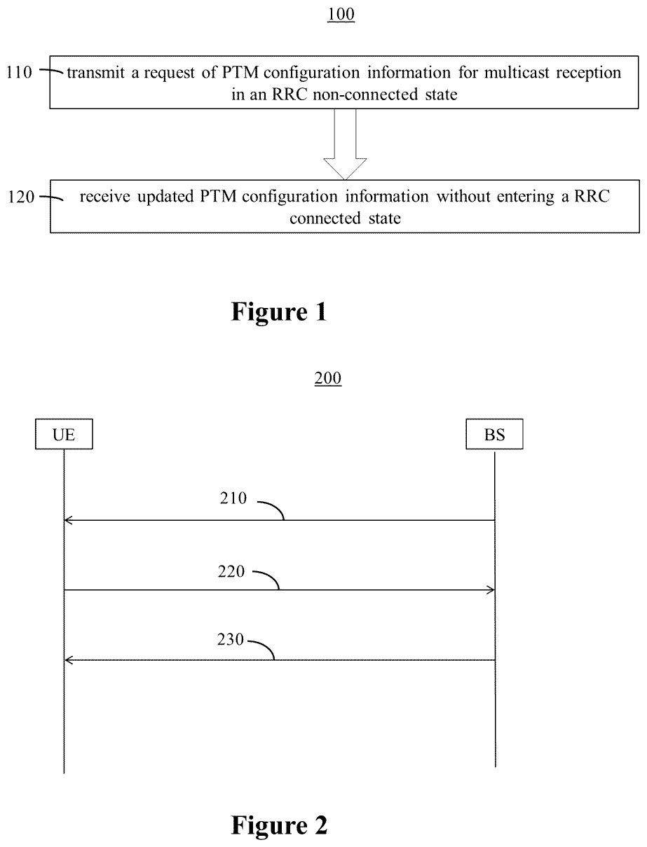

FIG. 1 illustrates an exemplary flow chart of a method 100 performed by a UE according to some embodiments of the present disclosure.

As illustrated in FIG. 1, the method 100 at least includes step 110 and step 120. In step 110, the UE in a RRC non-connected state transmits a request of PTM configuration information for multicast reception. The BS transmits the updated PTM configuration information in response to receiving the request of PTM configuration information. Then, in step 120, the UE receives the updated PTM configuration information without entering a RRC connected state.

For example, the BS determines that the PTM configuration of the UE in a RRC non-connected state (not considering the UE in RRC connected state) needs to be updated. In other words, the BS determines that part or all of the parameters of the PTM configuration information need to be updated. The PTM configuration information may be associated with a certain MBS session or a contain MRB. Then, the BS (or the network) initiates a PTM configuration update procedure. The BS may transmit a paging message to the UE in the RRC non-connected state, indicating that update of the PTM configuration information for the multicast reception is required. The PTM configuration information may refer to all related parameters for the multicast reception, e.g., including packet data convergence protocol (PDCP), medium access control (MAC), radio link control (RLC) and physical related parameters.

Information included in the paging message, which indicates that update of the PTM configuration information for the multicast reception is required, is various. For example, in some embodiments of the present disclosure, the paging message includes an indication indicating that update of the PTM configuration information for the multicast is required. In some other embodiments of the present disclosure, the paging message includes an MBS session ID of the multicast reception e.g., if the UE is receiving or interested in the MBS session identified by the MBS session ID, and the UE treats the update of the PTM configuration information for the multicast reception is required. In some yet other embodiments of the present disclosure, the paging message includes both an indication indicating that update of the PTM configuration information for the multicast is required, and an MBS session ID of the multicast reception and the UE is receiving or interested in the MBS session identified by the MBS session ID.

After receiving the paging message from the BS, in step 110, the UE in the RRC non-connected state may transmit the request of PTM configuration information to the BS via a RRC resume request message. In step 120, the updated PTM configuration information will be received via a RRC release message which is transmitted from the BS in response to the RRC resume request message.

FIG. 2 illustrates an exemplary procedure 200 of the method according to some embodiments of the present application. It is contemplated that for simplicity and conciseness, only necessary signaling is illustrated in FIG. 2 according to the spirit of some embodiments of the present application.

Referring to FIG. 2, the BS determines that the PTM configuration of the UE in a RRC non-connected state, e.g., RRC inactive state needs to be updated. The BS will initiate a PTM configuration update procedure by transmitting a paging message in step 210 indicating that the PTM configuration information update for the multicast reception is required. The UE will receive the paging message. For example, the paging message may include an indication indicating that update of the PTM configuration information for the multicast is required, or includes an MBS session ID of the multicast reception, or includes the both.

In some scenarios, there is no need to resume the UE into a RRC_CONNECTED state. The UE will transmit a RRC resume request message in step 220, including a request of PTM configuration information. The request of PTM configuration information is used to indicate that the RRC resume request message is only for acquiring the updated multicast PTM configuration, that is, there is no other data transmission is required.

After receiving the RRC resume request message including the request of PTM configuration information, the BS will transmit a RRC release message in step 230, including the updated PTM configuration information to the UE. The UE will receive the RRC release message.

According to some embodiments of the present disclosure, the BS contains separated CU and DU, and the DU is coupled to the CU. The DU or the CU may determine that the PTM configuration of at least one UE associated with a certain MBS session ID needs to be updated and initiate the PTM configuration update procedure, wherein the at least one UE may be in the RRC non-connected state. Accordingly, there may be signaling interaction between the CU and the DU separated from and coupled to the CU.

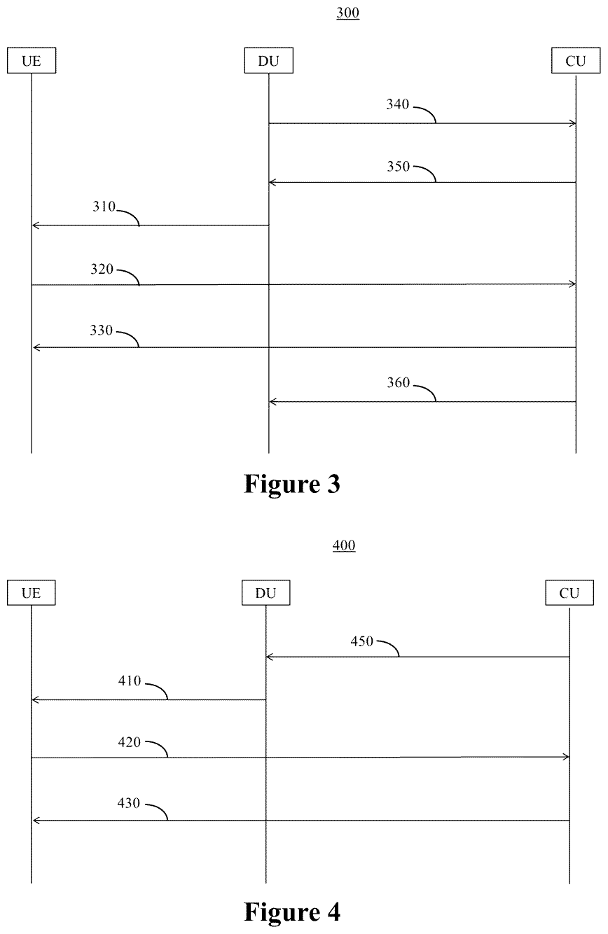

FIG. 3 illustrates an exemplary procedure 300 of the method according to some embodiments of the present application, where the DU determines that the PTM configuration associated with a certain MBS session or an MRB needs to be updated and initiates the PTM configuration update procedure.

Referring to FIG. 3, the DU transmits a PTM configuration update request message in step 340 to the CU to initiate the PTM configuration update procedure. In some embodiments of the present disclosure, PTM configuration update request message uses non-UE associated signaling. The non-UE associated PTM configuration update request message may include at least one of: an MRB ID, an MBS session ID, a G-RNTI, or a cell ID.

After receiving the non-UE associated PTM configuration update request message, the CU determines the impacted UE is in RRC inactive state and transmit a RAN paging message to the DU for the UE in step 350. The RAN paging message includes an indication indicating that update of the PTM configuration information associated with the certain MBS session or a certain MRB is required.

After receiving the RAN paging message, the DU will transmit a paging message in step 310 (similar to or as the same as the paging message descried in 210) to at least one UE associated with the certain MBS session or the MRB. When a UE in a RRC non-connected state associated with the certain MBS session ID or the certain MRB ID receives the paging message, it may transmit a RRC resume request message in 320 (similar to or as the same as the RRC resume request message described in step 220) including the request of PTM configuration information to the CU. The request of PTM configuration information is used to indicate that the RRC resume request message is for acquiring the updated multicast PTM configuration, which implies there is no need to resume the UE into the RRC connected state. After receiving such a RRC resume request message, the CU may transmit the RRC release message in step 330 (similar to or as the same as the RRC release message described in 230) including the updated PTM configuration information.

In some embodiments of the present disclosure, after the UE updates the PTM configuration associated with the MBS session or the MRB, the CU may transmit a non-UE associated PTM configuration update acknowledge (ACK) message in step 360 to the DU, indicating that PTM configuration associated with the MBS session or the MRB has been updated.

It is contemplated that although only one UE is illustrated in FIG. 3, there may be one or more UEs in the RRC non-connected state associated with the MBS session ID may receive the paging message in step 310 and subsequently update their PTM configuration associated with the MBS session ID following the same or similar procedure.

According to some other embodiments of the present disclosure, the CU rather than the DU may determine that the PTM configuration of the UE in the RRC non-connected state needs to be updated and initiate the PTM configuration update procedure.

In this case, the CU may directly transmit a RAN paging message to the DU. After the UE updates the PTM configuration, the CU does not need to confirm with the DU that the PTM configuration has been updated.

FIG. 4 illustrates an exemplary procedure 400 of the method according some embodiments of the present application, wherein the CU determines that the PTM configuration associated with a certain MBS session or an MRB needs to be updated and initiates the PTM configuration update procedure.

Referring to FIG. 4, the CU determines that the PTM configuration of at least one UE associated with a certain MBS session or an MRB needs to be updated. The CU will transmit a RAN paging message 450 to the DU. The RAN paging message 450 includes an indication indicating that update of the PTM configuration information associated with the certain MBS session or the MRB is required.

After receiving the RAN paging message, the DU will transmit the paging message in step 410 to the at least one UE associated with the certain MBS session or the MRB When a UE in a RRC non-connected state receives the paging message 410, it may transmit RRC resume request message to the CU in step 420, including the request of PTM configuration information. The request of PTM configuration information is used to indicate that the RRC resume request message is for acquiring the updated multicast PTM configuration, which implies there is no need to resume the UE into a RRC connected state. After receiving such a RRC resume request message, the CU may transmit the RRC release message in step 430 including updated PTM configuration information.

It is contemplated that although only one UE is illustrated in FIG. 4, there may be one or more UEs in the RRC non-connected state associated with the MBS session or the MRB may receive the paging message and subsequently update their PTM configuration associated with the MBS session or the MRB.

According to some embodiments of the present disclosure, a UE may initiate the PTM configuration update procedure. For example, when a UE in a RRC non-connected state performs cell selection or cell reselection to a new cell without valid PTM configuration for the UE, the UE may initiate a PTM configuration update procedure to continuously perform multicast reception in the RRC non-connected state.

For example, the UE may transmit a request of PTM configuration information to a new serving BS, i.e., a receiving BS. In some embodiments of the present disclosure, the UE may transmit the request of PTM configuration information in a RRC resume request message. The request of PTM configuration information is used to indicate that the RRC resume request message is for acquiring multicast PTM configuration for a new serving cell and there is no need to resume the UE into RRC connected state. After receiving such a request of PTM configuration information, the new serving BS may forward the request of PTM configuration information to the last serving BS (i.e., the anchor BS) for anchor relocation decision, generate valid PTM configuration information for the UE, and transmit the valid PTM configuration information to the UE, e.g., via a RRC release message.

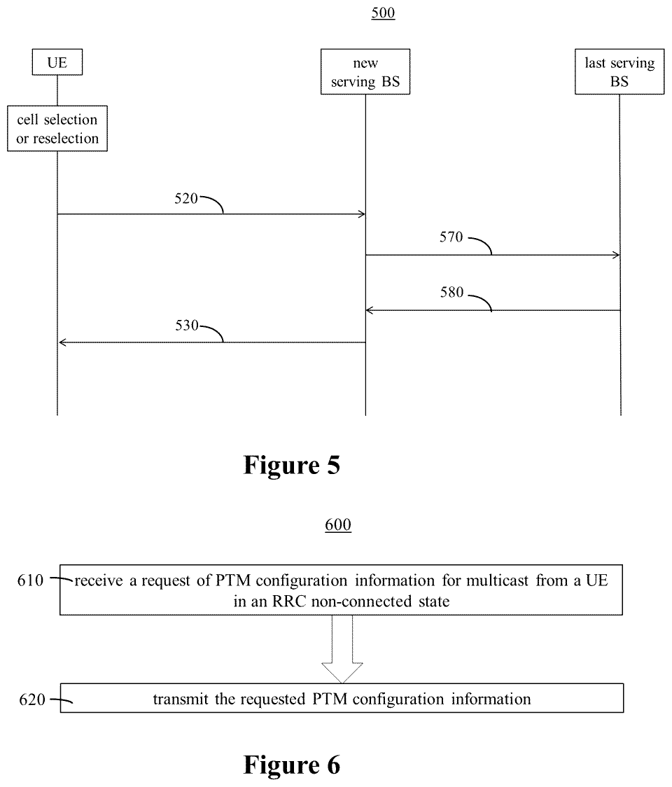

FIG. 5 illustrates an exemplary procedure 500 of a method according to some embodiments of the present application, where a UE performing multicast reception in the RRC non-connected state performs cell selection or cell reselection to a new serving cell.

Referring to FIG. 5, in some scenarios, the UE may perform cell selection or cell reselection to a new serving cell without valid PTM configuration for the UE. To continuously perform multicast reception, the UE transmits a RRC resume request message in step 520 to the new serving BS. The RRC resume request message may include a request of PTM configuration information, which is used to indicate that the RRC resume request message is for acquiring the updated multicast PTM configuration and there is no need to resume the UE into a RRC connected state.

After receiving the RRC resume request message, the new serving BS transmits a UE context retrieve request message in step 570 to the last serving BS (i.e., the anchor BS). The UE context retrieve request message includes a Xn interface request of PTM configuration information.

According to at least the Xn interface request of PTM configuration information, the last serving BS determines to perform anchor relocation to the new serving BS by sending the UE context retrieve response message in step 580, including the PTM configuration for the UE.

After receiving the UE context retrieve response message from the last serving BS, the new serving BS may generate updated PTM configuration information at least partly based on the UE context retrieve response message and transmit the updated PTM configuration information to the UE via e.g., the RRC release message

In some cases, for a UE capable of performing multicast reception in the RRC non-connected state, if it transits from the RRC non-connected state to the RRC connected state, the UE may transmit information associated with multicast reception of the UE to assist the serving BS to determine a subsequent RRC state of the UE for the multicast reception.

In some embodiments of the present disclosure, the information associated with multicast reception is transmitted via a RRC resume complete message, UE assistance information message, or MBS interest indication message.

In some embodiments of the present disclosure, the information associated with multicast reception includes at least one of: latest measurement results of a serving cell in the RRC non-connected state; a UE preference indication on RRC state of multicast reception; or a multicast reception status of the UE in the RRC non-connected state.

The latest measurement results of the serving cell in the RRC non-connected state include at least one of: the measured reference signal receiving power (RSRP) or reference signal receiving quality (RSRQ) (i.e., RSRP and/or RSRQ) of the serving cell. The UE may include the measured RSRP and/or RSRQ if the configured condition is fulfilled, e.g., in the case that the measured RSRP and/or RSRQ is equal to or larger than a threshold. The UE preference indication on RRC state of multicast reception may include whether the UE prefers to stay in the RRC inactive state or enter RRC connected state for the multicast reception. The UE preference indication on RRC state of multicast reception may be per MBS session or per MRB. The multicast reception status of the UE in the RRC non-connected state may indicate the multicast reception status is good, normal, or bad in the RRC non-connected state. The multicast reception status of the UE in the RRC non-connected state may include receiving bit rate error information.

In some embodiments of the present disclosure, for a UE performing multicast reception in the RRC non-connected state, if it further performs a cell selection or cell reselection to a cell without valid PTM configuration, or receives a paging message indicating that the PTM configuration information update is required, the UE may transit from the RRC non-connected state to the RRC connected state.

It is contemplated that the BS will execute corresponding methods according to various embodiments provided by the present disclosure.

FIG. 6 illustrates an exemplary flow chart of a method 600 performed by a BS corresponding to the method 100 performed by a UE, according to some embodiments of the present disclosure.

As illustrated in FIG. 6, the method 600 mainly include step 610 and step 620. In step 610, the BS receives a request of PTM configuration information for multicast from a UE in a RRC non-connected state, e.g., via a RRC resume request message. The request of PTM configuration information is used to indicate that the RRC resume request message is only for acquiring the updated multicast PTM configuration, that is there is no other data transmission is required. In step 620, the BS transmits the updated PTM configuration information to the UE, e.g., via a RRC release message.

For example, the BS determines that the PTM configuration of the UE in a RRC non-connected state (not considering the UE in RRC connected state) needs to be updated. In other words, the BS determines that part or all of the parameters of the PTM configuration information need to be updated. The PTM configuration information may be associated with a certain MBS session or a contain MRB. Then, the BS (or the network) initiates a PTM configuration update procedure. The BS may transmit a paging message to the UE in the RRC non-connected state, indicating that update of the PTM configuration information for the multicast reception is required. The PTM configuration information may refer to all related parameters for the multicast reception, e.g. including PDCP, MAC, RLC and physical related parameters.

In response to reception of such a paging message, the UE in a RRC non-connected state transmits the request of PTM configuration information for multicast. Correspondingly, in step 610, the BS receives the request of PTM configuration information for multicast.

In some embodiments of the present disclosure, the BS includes a DU and a CU. Then the DU or the CU may initiate the PTM configuration update procedure, and there may be signaling interaction between the DU and the CU. Please refer to FIG. 3 and FIG. 4 as examples.

According to some embodiments of the present disclosure, the UE may initiate the PTM configuration update procedure due to cell selection or cell reselection to a cell without valid PTM configuration for the UE, wherein the UE is capable of performing multicast reception in the RRC non-connected state. In this case, the BS is the serving BS without valid PTM configuration for the UE.

In some embodiments of the present disclosure, after receiving a request of PTM configuration information for multicast from a UE in an RRC non-connected state, the serving BS may transmit a UE context retrieve request message to a last serving BS of the UE, wherein the UE context retrieve request message includes the request of PTM configuration information; after receiving the UE context retrieve request message, the last serving BS may determine to perform anchor relocation to the serving BS by sending the UE context retrieve request message which includes the PTM configuration information; after receiving the UE context retrieve response message from the last serving BS, the serving BS generates the PTM configuration information at least partly based on the UE context retrieve response message. After generating the PTM configuration information, the serving BS will transmit the requested PTM configuration information to the UE.

According to some embodiments of the present disclosure, the BS receives information associated with multicast reception from a UE after an initiation of state transition of the UE from a RRC non-connected state to a RRC connected state, and determines the subsequent RRC state of the UE used for the multicast reception based on at least the received information associated with the multicast reception.

Given the above embodiments, for a UE capable of performing multicast reception in a RRC non-connected state, some aforementioned methods or embodiments of the present disclosure provide a solution to support reconfiguration of the dedicated multicast PTM configuration without entering a RRC connected state. A UE, a BS or a CU or a DU within the BS may initiate the PTM configuration update procedure.

For a UE capable of performing multicast reception in a RRC non-connected state, some aforementioned other methods or embodiments of the present disclosure teach when the UE transits to a RRC connected state, the UE may provide multicast reception assisted information to the network so that the BS (or a network) may decide whether to send the UE back to the RRC non-connected state.

These various methods and embodiments can reduce RRC state transition frequency, reduce communication latency, signaling overhead, service interruptions, and improve user experience.

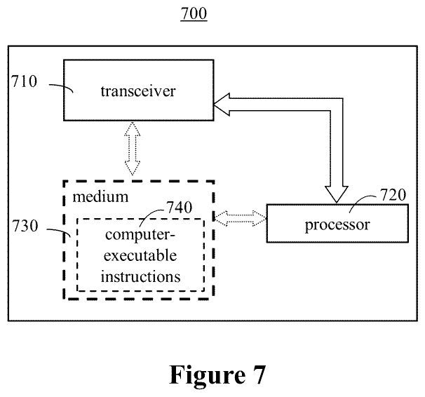

FIG. 7 illustrates a simplified block diagram of an exemplary apparatus 700 according to some embodiments of the present disclosure.

In some embodiments of the present disclosure, apparatus 700 may be or include at least a part of a UE or similar device that can use the technology of the present disclosure, for example, the UE is capable of performing multicast reception in a RRC non-connected state.

In some embodiments of the present disclosure, apparatus 700 may be or include at least a part of a BS or similar device that can use the technology of the present disclosure, for example, the BS is capable of performing multicast with at least one UE in the RRC non-connected state.

As shown in FIG. 7, the apparatus 700 may include at least transceiver 710 and processor 720, wherein transceiver 710 may be coupled to processor 720, and transceiver 710 includes at least one transmitter and at least one receiver. Furthermore, apparatus 700 may include non-transitory computer-readable medium 730 with computer-executable instructions 740 stored thereon, wherein non-transitory computer-readable medium 730 may be coupled to processor 720, and computer-executable instructions 740 may be configured to be executable by processor 720. In some embodiments of the present disclosure, transceiver 710, non-transitory computer-readable medium 730, and processor 720 may be coupled to each other via one or more local buses.

Although in FIG. 7, elements such as transceiver 710, non-transitory computer-readable medium 730, and processor 720 are described in the singular, the plural is contemplated unless limitation to the singular is explicitly stated. In certain embodiments of the present disclosure, the apparatus 700 may further include other components for actual usage.

In some embodiments of the present disclosure, the apparatus 700 is a UE or at least a part of a UE. The processor 720 is configured to cause the apparatus 700 at least to perform, with transceiver 710, any method (e.g., the method 100) described above which is performed by a UE according to some embodiments of the present disclosure.

In some embodiments of the present disclosure, the receiver is configured to receive multicast in a RRC non-connected state; the transmitter configured to: transmit a request of PTM configuration information for the multicast reception in the RRC non-connected state, or transmit information associated with multicast reception of the UE after an initiation of state transition of the UE from a RRC non-connected state to a RRC connected state to assist deciding a subsequent RRC state used for the multicast reception.

In some embodiments of the present disclosure, the apparatus 700 is a BS or at least a part of a BS. The processor 720 is configured to cause the apparatus 700 at least to perform, with transceiver 710, any method described (e.g., the method 600) above which is performed by a BS according to some embodiments of the present disclosure.

According to some embodiments of the present disclosure, the transceiver 710 is configured to: receive a request of PTM configuration information for multicast reception from a UE in an RRC non-connected state; and transmit the requested PTM configuration information.

According to some other embodiments of the present disclosure, transceiver 710 is configured to: receive, via the transceiver 710, information associated with multicast reception from a UE after an initiation of state transition of the UE from the RRC non-connected state to a RRC connected state; and determine a subsequent RRC state used for the multicast reception based on the received information.

It is contemplated that the BS executes corresponding methods according to some embodiments of the present disclosure.

In various example embodiments, the processor 720 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 720 may also include at least one other circuitry or element not shown in FIG. 7.

In various example embodiments, the non-transitory computer-readable medium 730 may include at least one storage medium in various forms, such as a volatile memory and/or a non-volatile memory. The volatile memory may include, but is not limited to, for example, a RAM, a cache, and so on. The non-volatile memory may include, but is not limited to, for example, a ROM, a hard disk, a flash memory, and so on. Further, the non-transitory computer-readable medium 730 may include, but is not limited to, an electric, a magnetic, an optical, an electromagnetic, an infrared, or a semiconductor system, apparatus, or device or any combination of the above.

Further, in various example embodiments, the apparatus 700 may also include at least one other circuitry, element, and interface, for example antenna element, and the like.

In various example embodiments, the circuitry, parts, elements, and interfaces in the apparatus 700 may be coupled together via any suitable connections including, but not limited to, buses, crossbars, wiring and/or wireless lines, in any suitable ways, for example electrically, magnetically, optically, electromagnetically, and the like.

In some cases, the BS includes at least one DU and a CU, for each CU or DU, there is at least one coupled transceiver; herein the at least one DU is separated from and coupled with the CU. The BS may execute the aforementioned operations. Furthermore, in some embodiments of the present disclosure, there are signaling interaction between the CU and the at least one DU, please refer to signaling flow charts illustrated in FIG. 3, FIG. 4, and FIG. 5 as examples.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “comprising,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.”

In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configure to cause the UE to:
receive multicast in a radio resource control (RRC) non-connected state; and a
transmit a request of point-to-multipoint (PTM) configuration information for multicast reception in the RRC non-connected state; or
transmit information associated with multicast reception of the UE after an initiation of state transition from the RRC non-connected state to a RRC connected state to assist deciding a subsequent RRC state used for the multicast reception.

2. The UE of claim 1, wherein the request of PTM configuration information is transmitted via a RRC resume request message, and updated PTM configuration information is received via a RRC release message in response to the RRC resume request message without entering the RRC connected state.

3. The UE of claim 1, wherein the request of PTM configuration information is transmitted in response to receiving a paging message with an indication indicating that update of the PTM configuration information for the multicast is required.

4. The UE of claim 1, wherein the request of PTM configuration information is transmitted in response to receiving a paging message with a multicast broadcast service (MBS) session identifier (ID) of the multicast reception in the case that the UE is receiving or is interested in the MBS session identified by the MBS session ID.

5. The UE of claim 1, wherein the request of PTM configuration information is transmitted in response to cell selection or cell reselection to a cell without valid PTM configuration information for the UE.

6. The UE of claim 1, wherein the information associated with multicast reception comprises at least one of:
latest measurement results of a serving cell in the RRC non-connected state;
a UE preference indication on RRC state of multicast reception; or
a multicast reception status of the UE in the RRC non-connected state.

7. A base station (BS) for wireless communication, comprising:
at least one memory; and
at least one processor coupled with the at least one memory and configure to cause the BS to:
receive a request of point-to-multipoint (PTM) configuration information for multicast reception from a user equipment (UE) in a radio resource control (RRC) non-connected state; and
transmit the updated PTM configuration information; or
receive information associated with multicast reception from the UE after an initiation of state transition of the UE from the RRC non-connected state to a RRC connected state and
determine a subsequent RRC state used for the multicast reception of the UE based on the received information.

8. The BS of claim 7, wherein the request of PTM configuration information is received via a RRC resume request message, and updated PTM configuration information is transmitted via a RRC release message in response to the RRC resume request message.

9. The BS of claim 7, wherein the request of PTM configuration information is received after transmitting a paging message with an indication indicating that update of the PTM configuration information for the multicast is required.

10. The BS of claim 7, wherein the request is received after transmitting a paging message with a multicast broadcast service (MBS) session identifier (ID) of the multicast.

11. The BS of claim 7, wherein the BS comprises a central unit (CU) and a distributed unit (DU) coupled to the CU, and the DU transmits the paging message to the UE in response to receiving a radio access network (RAN) paging message including an indication indicating that update of the PTM configuration information is required from the CU.

12. The BS of claim 7, wherein the BS is a receiving BS of the UE in response to receiving the request of PTM configuration information from the UE, and the at least one processor is further configured to cause the BS to:
transmit a UE context retrieve request message to a last serving BS of the UE, wherein the UE context retrieve request message includes a Xn interface request of PTM configuration information;
receive a UE context retrieve response message from the last serving BS; and
generate the PTM configuration information at least partly based on the UE context retrieve response message.

13. The BS of claim 7, wherein the information associated with multicast reception is received via a RRC resume complete message, UE assistance information message, or multicast broadcast service (MBS) interest indication message.

14. The BS of claim 13, wherein the information associated with multicast reception comprises at least one of the following:
latest measurement results of a serving cell in the RRC non-connected state;
a UE preference indication on RRC state of multicast reception; or
a multicast reception status of the UE in the RRC non-connected state.

15. A method performed by a user equipment (UE), the method comprising:
receiving multicast in a radio resource control (RRC) non-connected state; and
transmitting a request of point-to-multipoint (PTM) configuration information for multicast reception in the RRC non-connected state; or
transmitting information associated with multicast reception of the UE after an initiation of state transition from the RRC non-connected state to a RRC connected state to assist deciding a subsequent RRC state used for the multicast reception.

16. A processor for wireless communication, comprising:
at least one controller coupled with the at least one memory and configure to cause the processor to:
receive multicast in a radio resource control (RRC) non-connected state; and
a
transmit a request of point-to-multipoint (PTM) configuration information for multicast reception in the RRC non-connected state; or
transmit information associated with multicast reception of the processor after an initiation of state transition from the RRC non-connected state to a RRC connected state to assist deciding a subsequent RRC state used for the multicast reception.

17. The processor of claim 16, wherein the request of PTM configuration information is transmitted via a RRC resume request message, and updated PTM configuration information is received via a RRC release message in response to the RRC resume request message without entering the RRC connected state.

18. The processor of claim 16, wherein the request of PTM configuration information is transmitted in response to receiving a paging message with an indication indicating that update of the PTM configuration information for the multicast is required.

19. The processor of claim 16, wherein the request of PTM configuration information is transmitted in response to receiving a paging message with a multicast broadcast service (MBS) session identifier (ID) of the multicast reception in the case that the UE is receiving or is interested in the MBS session identified by the MBS session ID.

20. The processor of claim 16, wherein the request of PTM configuration information is transmitted in response to cell selection or cell reselection to a cell without valid PTM configuration information for the processor.
